(19) United States
(12) Patent Application Publication
(10) Pub. No.: US 2024/0239080 A1
(43) Pub. Date: Jul. 18, 2024

(54) LAMINATED STRUCTURE AND METHOD FOR MANUFACTURING THE SAME

(71) Applicant: Murata Manufacturing Co., Ltd., Nagaokakyo-shi (JP)

(72) Inventors: Yusuke ARAKAWA, Nagaokakyo-shi (JP); Ryotaro NAMBA, Nagaokakyo-shi (JP)

(21) Appl. No.: 18/623,486

(22) Filed: Apr. 1, 2024

Related U.S. Application Data
(63) Continuation of application No. PCT/JP2023/016624, filed on Apr. 27, 2023.

(30) Foreign Application Priority Data
Jun. 7, 2022 (JP) 2022-092470

(51) Int. Cl. B32B 3/26; B32B 15/04; B32B 15/08; B32B 27/28; B32B 38/00

(52) U.S. Cl. CPC B32B 3/263; B32B 15/043; B32B 15/08; B32B 27/28; B32B 38/0036; B32B 2250/03; B32B 2311/12; B32B 2311/22

(57) ABSTRACT

A laminated structure that includes: a resin substrate; a barrier film on the resin substrate and containing a first metal element; and a metal layer on the barrier film and containing a second metal element, where a part of the metal layer penetrates the barrier film and extends to an inside of the resin substrate.

### CROSS REFERENCE TO RELATED APPLICATIONS

The present application is a continuation of International application No. PCT/JP2023/016624, filed Apr. 27, 2023, which claims priority to Japanese Patent Application No. 2022-092470, filed Jun. 7, 2022, the entire contents of each of which are incorporated herein by reference.

### TECHNICAL FIELD

The present invention relates to a laminated structure including a resin substrate, a barrier film, and a metal layer, and a method for manufacturing the laminated structure.

### BACKGROUND ART

Establishing a technique of coating a resin substrate with a metal layer such as a plating layer enables replacing a part of a product conventionally produced only with a metal material by a resin material, and provides various advantages such as weight reduction, cost reduction, improvement in the degree of freedom of shape, and facilitation of mass production of the product.

Meanwhile, the adhesion between a resin substrate and a metal layer (particularly, a plating layer) is known to be low. The improvement measure most frequently used for improving the adhesion between a resin substrate and a plating layer is roughening of the surface of the resin substrate (see, for example, Patent Documents 1 to 4).

Patent Document 1 discloses a treatment of a plastic before metal plating, using an etching treatment liquid containing a permanganate and an inorganic acid.

Patent Document 2 discloses a method, as a pretreatment method for electroless plating of a surface of a polycarbonate molded article, in which a polycarbonate molded article is immersed in an alkaline aqueous solution and then subjected to a surface treatment using a hydrogen carbonate compound aqueous solution and ozone.

Patent Document 3 discloses a resin plating treatment method in which a syndiotactic polystyrene-based resin is subjected to electroless plating and then subjected to resin plating by electrolytic plating, including an ozone water treatment, as a plating pretreatment in place of chromic acid etching or the like, in which the syndiotactic polystyrene-based resin is brought into contact with an ozone aqueous solution.

Patent Document 4 discloses a method for plating pretreatment of a surface of an ABS-based resin, in which an ABS-based resin is treated with a solution containing persulfuric acid obtained by electrolyzing only sulfuric acid.

Furthermore, techniques have been studied for improving the adhesion between a resin substrate and a plating layer by a method other than roughening of a surface of a resin substrate (see, for example, Patent Documents 5 to 8).

Patent Document 5 discloses a method for forming a functional film on a resin product by (1) a step of introducing an acidic group into a resin product, (2) a step of treating the resin product from the step (1) with a metal ion-containing liquid, and (3) a step of forming a metal film on the resin product by a reduction treatment of the resin product from the step (2).

Patent Document 6 discloses an etching treatment with an ethyl alcohol solution containing ammonia in a step of etching a surface of a polyethylene terephthalate resin, applying a catalyst, and then performing electroless copper plating. Chemically dissolving and modifying the surface of the polyethylene terephthalate resin strengthens the chemical adhesion between the metal and the surface of the object to be plated and thus improves the adhesion strength of the copper plating film.

Patent Document 7 discloses a plated product including a substrate, a primer layer, a plating base coating film layer, and a metal plating film, in which adhesion between the primer layer and the plating base coating film layer is improved by controlling the kind and the content of a synthetic resin contained in the plating base coating film layer.

Patent Document 8 discloses drying and curing a synthetic resin latex on a surface of an electrically nonconductive substrate to form a primer layer, then forming a catalytic metal layer on the primer layer, and subjecting the catalytic metal layer to electroless plating to form a metal plating layer.
Patent Document 1: Japanese Patent Application Laid-Open No. 2008-31513
Patent Document 2: Japanese Patent Application Laid-Open No. 2002-121678
Patent Document 3: Japanese Patent Application Laid-Open No. 2012-52214
Patent Document 4: Japanese Patent No. 6953484
Patent Document 5: Japanese Patent No. 3475260
Patent Document 6: Japanese Patent Application Laid-Open No. H7-180062
Patent Document 7: Japanese Patent No. 5780635
Patent Document 8: Japanese Patent Application Laid-Open No. 2001-107257

### SUMMARY OF THE INVENTION

The techniques of roughening a resin substrate surface disclosed in Patent Documents 1 to 4 use a chemical liquid having a strong oxidizing power, and therefore may have an influence on the environment and a problem of waste liquid treatment. The techniques of treatment of a resin substrate surface disclosed in Patent Documents 5 to 8 use no such a chemical liquid, but the adhesion strength between the resin substrate and the metal layer is not stabilized, and thus the adhesion between them may be not improved.

Therefore, an object of the present invention is to provide a laminated structure that can be manufactured without using a chemical liquid having a strong oxidizing power and has high adhesion between a resin substrate and a metal layer, and a method for manufacturing the laminated structure.

According to one gist of the present invention, a laminated structure is provided that includes: a resin substrate; a barrier film on the resin substrate, the barrier film containing a first metal element; and a metal layer on the barrier film, the metal layer containing a second metal element, in which a part of the metal layer penetrates the barrier film and extends to an inside of the resin substrate.

According to another gist of the present invention, a method for manufacturing a laminated structure includes: heating a precursor laminate containing a resin substrate and a metal precursor on the resin substrate, the metal precursor containing a first metal element and a second metal element to form a laminated structure including: the resin substrate; a barrier film on the resin substrate and containing the first metal element; and a metal layer on the barrier film and containing the second metal element, the metal layer having a part in contact with the resin substrate through the barrier film, and the resin substrate having a metal diffusion region extending inward from a contact portion in contact with the metal layer, the metal diffusion region in which metal elements of a kind identical with a kind of the second metal element are diffused during the heating.

According to the present invention, it is possible to provide a laminated structure that can be manufactured without using a chemical liquid having a strong oxidizing power and has high adhesion between a resin substrate and a metal layer, and a method for manufacturing the laminated structure.

### BRIEF EXPLANATION OF THE DRAWINGS

FIG. 1 is a schematic perspective view of a laminated structure according to a first embodiment.

FIG. 2 is a schematic enlarged sectional view of the laminated structure in a section taken along the line X-x in FIG. 1.

FIG. 3A is a schematic enlarged sectional view for explaining a method for manufacturing a laminated structure according to a second embodiment-1.

FIG. 3B is a schematic enlarged sectional view for explaining the method for manufacturing a laminated structure according to the second embodiment-1.

FIG. 4A is a schematic enlarged sectional view for explaining a method for manufacturing a laminated structure according to a second embodiment-2.

FIG. 4B is a schematic enlarged sectional view for explaining the method for manufacturing a laminated structure according to the second embodiment-2.

FIG. 5 shows Table 2 showing test conditions and test results of Examples.

FIG. 6 shows Table 3 showing test conditions and test results of Examples.

FIG. 7 is a schematic enlarged sectional view of a first modification of a laminated structure according to a third embodiment.

FIG. 8 is a schematic enlarged sectional view of a second modification of the laminated structure according to the third embodiment.

FIG. 9 is a schematic enlarged sectional view of a third modification of the laminated structure according to the third embodiment.

FIG. 10A is a schematic enlarged sectional view of a first modification of a resin substrate according to a fourth embodiment.

FIG. 10B is a schematic enlarged sectional view of a second modification of the resin substrate according to the fourth embodiment.

FIG. 10C is a schematic enlarged sectional view of a third modification of the resin substrate according to the fourth embodiment.

### DETAILED DESCRIPTION OF THE INVENTION

Hereinafter, a laminated structure 10 according to a first embodiment of the present invention and a method for manufacturing a laminated structure 10 according to a second embodiment will be described with reference to the drawings. Furthermore, a modification of the laminated structure is shown in a third embodiment, and a modification of a resin substrate used in the laminated structure is shown in a fourth embodiment.

### First Embodiment: Laminated Structure 10

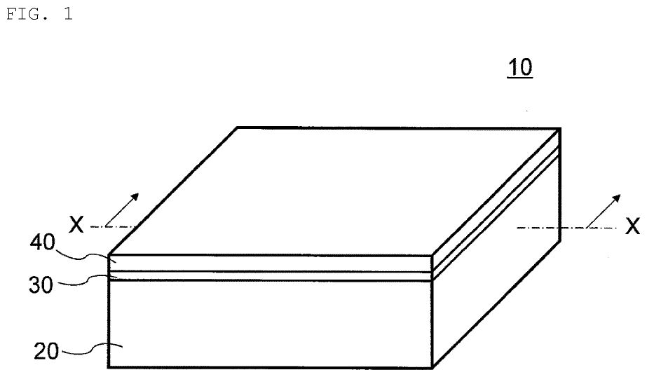

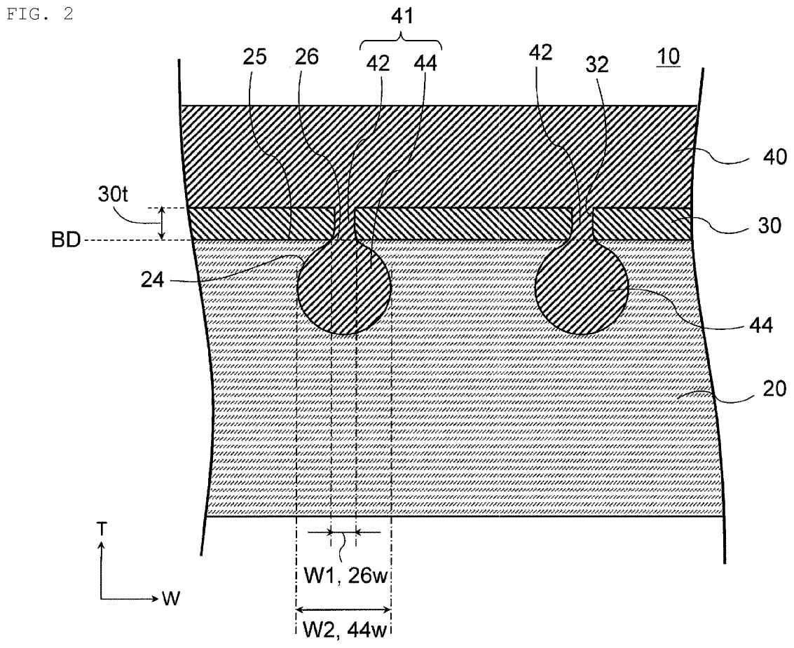

FIG. 1 is a schematic perspective view of a laminated structure 10 according to an embodiment, and FIG. 2 is a schematic enlarged sectional view of the laminated structure 10 in a section taken along the line X-X in FIG. 1 (section in the thickness direction of a resin substrate 20).

As shown in FIGS. 1 and 2, the laminated structure 10 includes the resin substrate 20, a barrier film 30 positioned on the resin substrate 20, and a metal layer 40 positioned on the barrier film 30.

In observation of a section, a section is observed near the center in top view of the laminated structure 10 (observed along the thickness direction (T direction) from the metal layer 40 side of the laminated structure 10). That is, a section passing through the vicinity of the center is created in top view, and the section is observed at a portion corresponding to the vicinity of the center in top view in the section. The term “vicinity of the center in top view” refers to the center of a circumscribed circle of the outer shape of the laminated structure 10 (for example, substantially rectangular shape) in top view and the vicinity of the center.

As shown in FIG. 2, a part 41 of the metal layer 40 penetrates the barrier film 30 and extends to the inside of the resin substrate 20. This structure can be rephrased as follows.

The barrier film 30 has a through hole 32 penetrating the barrier film 30 in the thickness direction. The resin substrate 20 includes a cavity 24 inside. The resin substrate 20 has a front surface 25 having an opening of the cavity 24, and the cavity 24 communicates with the through hole 32 of the barrier film 30 through the opening 26. The through hole 32 and the cavity 24 are filled with the part 41 of the metal layer 40.

Here, in the part 41 of the metal layer 40, a part filling the through hole 32 may be referred to as a “penetrating portion 42”, and a part filling the cavity 24 may be referred to as an “extending portion 44”.

In the laminated structure 10, the part 41 of the metal layer 40 extends to the inside of the resin substrate 20, and the part 41 can function as an anchor capable of fixing the metal layer 40 to the resin substrate 20. Therefore, the part 41 of the metal layer 40 can improve the adhesion between the resin substrate 20 and the metal layer 40.

As shown in FIG. 2, in a sectional view in the thickness direction of the resin substrate 20, a width W1 of the part 41 of the metal layer 40 at a position of an interface BD between the resin substrate 20 and the barrier film 30 is preferably smaller than a maximum width W2 of the part 41 of the metal layer 40 at the inside of the resin substrate 20. Here, the “width W1” and the “maximum width W2” are defined as dimensions measured in a direction (width direction: W direction) orthogonal to the thickness direction (T direction) of the resin substrate 20.

As shown in FIG. 2, the “width W1 of the part 41 of the metal layer 40 at the position of the interface BD” is substantially equal to a width 26w of the opening 26 of the cavity 24 of the resin substrate 20. The “maximum width W2 of the part 41 of the metal layer 40 at the inside of the resin substrate 20” is substantially equal to a maximum width 44w of the extending portion 44 in the cavity 24.

That is, the phrase that “the width W1 of the part 41 of the metal layer 40 at the position of the interface BD is smaller than the maximum width W2 of the part 41 of the metal layer 40” means almost the same as the phrase that the width 26w of the opening 26 of the cavity 24 is smaller than the maximum width 44w of the extending portion 44.

As described above, the part 41 of the metal layer 40 functions as an anchor capable of fixing the metal layer 40 to the resin substrate 20. If the width 26w of the opening 26 is smaller than the maximum width 44w of the extending portion 44, the extending portion 44 is less likely to come out of the opening 26. In particular, if the width 26w is significantly smaller than the maximum width 44w, the extending portion 44 cannot come out of the opening 26. Therefore, the anchor effect by the part 41 of the metal layer 40 is improved, and thus the adhesion between the resin substrate 20 and the metal layer 40 can be further improved.

In the present description, the “position of the interface BD between the resin substrate 20 and the barrier film 30” is a position where a boundary (plane) between the resin substrate 20 and the barrier film 30 is present. As can be seen from FIG. 2, the part 41 of the metal layer 40 forms a hole in the interface BD between the resin substrate 20 and the barrier film 30. In the hole, the resin substrate 20 and the barrier film 30 are absent, so that the “interface BD” is absent in the hole. Therefore, a plane is imaged that covers the hole by extending the interface BD present around the hole, and the imaged plane is regarded as the “interface BD” in the hole of the interface BD.

In a case where minute irregularities are present at the boundary between the resin substrate 20 and the barrier film 30, that is, in a case where the interface BD between the resin substrate 20 and the barrier film 30 is not strictly a “plane”, a plane passing through an almost middle position between a mountain portion (protrusion) and a valley portion (recess) is imaged, and the imaged plane is treated as the “interface BD”.

It is preferable that a first metal element contained in the barrier film 30 and a second metal element contained in the metal layer 40 have different diffusion coefficients into the resin substrate 20, and that the first metal element have a smaller diffusion coefficient into the resin substrate 20 than the second metal element. More specifically, when the melting point of a resin material used in the resin substrate 20 is represented by Tm° C., the first metal element preferably has a smaller diffusion coefficient into the resin substrate 20 than the second metal element in a temperature range of more than (Tm−30)° C. and less than Tm° C. This temperature range corresponds to a heating condition in the step of heating a precursor laminate 60 in the second embodiment (method for manufacturing laminated structure 10).

As described in detail in a first method for manufacturing the laminated structure 10, heating makes the metal layer 40 enter into the inside of the resin substrate 20, and thus the extending portion 44 is formed. If the second metal element has a relatively large diffusion coefficient into the resin substrate 20, the metal layer 40 containing the second metal element is encouraged to enter the resin substrate 20, and thus the extending portion 44 can be easily formed.

If the first metal element has a relatively small diffusion coefficient into the resin substrate 20, the barrier film 30 containing the first metal element is less likely to enter the resin substrate 20, and can remain while maintaining the film state. Therefore, the barrier function of the barrier film 30, that is, the function of inhibiting the metal layer 40 from entering the resin substrate 20 through other than the through hole 32 is enhanced.

The first metal element preferably comprises one or more of Fe, V, Ni, Ti, Ca, Ag, Zn, Al, Mg, Rh, Pt, Au, and Pd, and the second metal element preferably comprises one or more of Co, Mn, and Cu.

The barrier film 30 may be made of only the first metal element, or may further contain another element together with the first metal element as long as the barrier function of the barrier film 30 is not inhibited.

The metal layer 40 may be made of only the second metal element, or may further contain another element together with the second metal element as long as formation of the extending portion 44 is not inhibited.

A thickness 30t of the barrier film 30 is not particularly limited, and is, for example, 0.005 μm to 1 μm (5 nm to 1000 nm), and preferably 0.01 μm to 0.1 μm (10 nm to 100 nm). If the thickness 30t of the barrier film 30 is 0.005 μm or more, the barrier function of the barrier film 30 can be sufficiently exhibited. If the thickness 30t is 1 μm or less, the through hole 32 penetrating the barrier film 30 can be easily formed in the method for manufacturing the laminated structure 10 described below.

In measurement of the thickness 30t of the barrier film 30, first, element mapping of section EDX observation of the laminated structure 10 is confirmed, and the range (shape) of the barrier film 30 is specified from the part (range) containing the first metal element. Next, the thickness of the barrier film 30 is measured at arbitrary 5 points, and the average of the measured values is regarded as the “thickness 30t of the barrier film 30”.

The resin substrate 20 is not particularly limited as long as a part of the metal layer 40 can enter the resin substrate 20, and for example, the resin substrate 20 can contain one or more of polymers of acrylonitrile-butadiene-styrene (ABS), polycarbonate/acrylonitrile-butadiene-styrene (PC/ABS), acrylonitrile-styrene-acrylate (ASA), silicon-based composite rubber-acrylonitrile-styrene (SAS), noryl, polypropylene, polycarbonate (PC), a polycarbonate-based alloy, acrylonitrile-styrene, polyacetate, polylactic acid, polystyrene, polyamide, aromatic polyamide, polyethylene, polyether ketone, polyethylene terephthalate, polybutylene terephthalate, polysulfone, polyether ether sulfone, polyether imide, modified polyphenylene ether, polyphenylene sulfide, polyphenylene oxide, polyimide, modified polyimide, an epoxy resin, a cycloolefin polymer, polynorbornene, a perfluoroalkoxy fluorine polymer, polytetrafluoroethylene, vinylidene fluoride, a vinyl resin, a phenol resin, polyacetal, nylon, a liquid crystal polymer, and copolymers of the polymers.

### Second Embodiment: Method for Manufacturing Laminated Structure 10

Two manufacturing methods (first and second methods for manufacturing) suitable for manufacturing the laminated structure 10 according to the first embodiment will be described below.

Both of the manufacturing methods include a step of heating a precursor laminate containing the resin substrate 20 and a metal precursor positioned on the resin substrate 20 and containing the first metal element and the second metal element.

The first method for manufacturing and the second method for manufacturing are different from each other in the form of the metal precursor.

### Second Embodiment-1: First Method for Manufacturing Laminated Structure 10

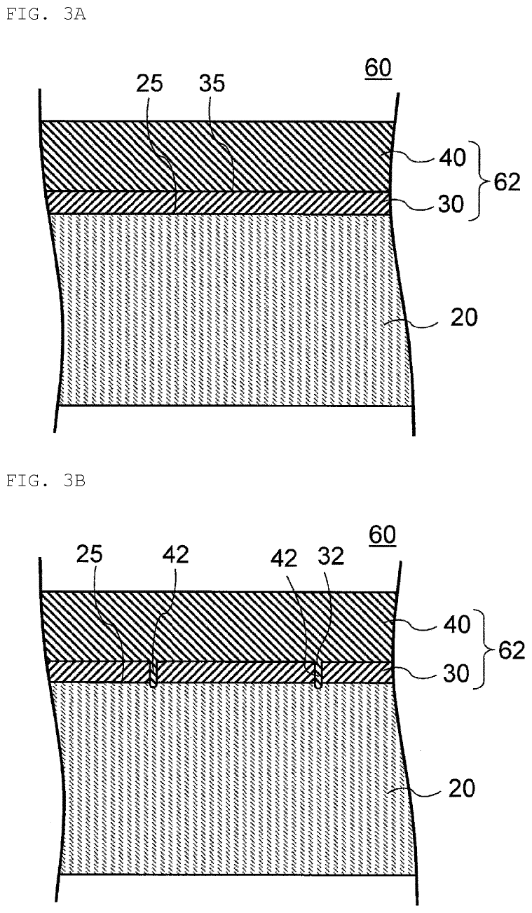

FIGS. 3A and 3B are schematic enlarged sectional views for explaining the first method for manufacturing the laminated structure 10.

The first method for manufacturing the laminated structure 10 includes a step of heating a precursor laminate 60 containing the resin substrate 20 and a metal precursor 62 positioned on the resin substrate 20 and containing the first metal element and the second metal element. As shown in FIG. 3A, in the first method for manufacturing according to the second embodiment-1, the metal precursor 62 has a two-layer structure including the barrier film 30 disposed on the resin substrate 20 and containing the first metal element and the metal layer 40 disposed on the barrier film 30 and containing the second metal element. The barrier film 30 shown in FIG. 3A is a continuous film without the through hole 32 (see FIG. 2).

The metal precursor 62 is formed by sequentially layering the barrier film 30 and the metal layer 40 on the resin substrate 20. For forming the barrier film 30, a film of a metal material containing the first metal element (corresponding to the barrier film 30) is formed on the front surface 25 of the resin substrate 20 by, for example, electroless plating, a sputtering method, or the like. For forming the metal layer 40, a film of a metal material containing the second metal element (corresponding to the metal layer 40) is formed on a surface 35 of the barrier film 30 by, for example, electrolytic plating, electroless plating, a sputtering method, or the like.

In a case where the barrier film 30 is formed on the resin substrate 20 by electroless plating, the front surface 25 of the resin substrate 20 is preferably pretreated with a known pretreatment method such as catalyst application.

It is preferable that the first metal element contained in the barrier film 30 and the second metal element contained in the metal layer 40 have different diffusion coefficients into the resin substrate 20, and that the first metal element have a smaller diffusion coefficient into the resin substrate 20 than the second metal element.

The second metal element has a relatively large diffusion coefficient into the resin substrate 20, and therefore the step of heating can make the metal layer 40 containing the second metal element enter the resin substrate 20. Thus, the extending portion 44 can be easily formed from the metal layer 40. Formation of the extending portion 44 will be described below with reference to FIGS. 3B and 2.

Meanwhile, the first metal element has a relatively small diffusion coefficient into the resin substrate 20, and therefore the barrier film 30 containing the first metal element is less likely to enter the resin substrate 20 and easily keeps the film shape in the step of heating. That is, the barrier film 30 tends to remain between the resin substrate 20 and the metal layer 40 after the step of heating. In other words, the barrier film 30 allows the part 41 of the metal layer 40 to enter the resin substrate 20, but restrains the entire metal layer 40 from entering the resin substrate 20. As described above, if the first metal element has a small diffusion coefficient, the barrier film 30 having a high barrier function can be formed.

As described above, the first metal element preferably comprises one or more of Fe, V, Ni, Ti, Ca, Ag, Zn, Al, Mg, Rh, Pt, Au, and Pd, and the second metal element preferably comprises one or more of Co, Mn, and Cu.

The material for formation of the barrier film 30 may be made of only the first metal element, or may further contain another element together with the first metal element as long as the barrier function of the barrier film 30 is not inhibited.

The material for formation of the metal layer 40 may be made of only the second metal element, or may further contain another element together with the second metal element as long as formation of the extending portion 44 is not inhibited.

The thickness of the barrier film 30 at the time of film formation (thickness of the barrier film 30 before the step of heating) is not particularly limited, and is, for example, 0.005 μm to 1 μm (5 nm to 1000 nm), and preferably 0.01 μm to 0.1 μm (10 nm to 100 nm). If the thickness of the barrier film 30 is 0.005 μm or more, the barrier function of the barrier film 30 can be sufficiently exhibited. If the thickness is 1 μm or less, the through hole 32 penetrating the barrier film 30 can be easily formed in the step of heating.

The thickness of the barrier film 30 before the step of heating can be measured with a method similar to the method of measuring the thickness 30t of the barrier film 30 described in the first embodiment.

As described above, the resin substrate 20 can contain, for example, one or more of polymers of acrylonitrile-butadiene-styrene (ABS), polycarbonate/acrylonitrile-butadiene-styrene (PC/ABS), acrylonitrile-styrene-acrylate (ASA), silicon-based composite rubber-acrylonitrile-styrene (SAS), noryl, polypropylene, polycarbonate (PC), a polycarbonate-based alloy, acrylonitrile-styrene, polyacetate, polylactic acid, polystyrene, polyamide, aromatic polyamide, polyethylene, polyether ketone, polyethylene terephthalate, polybutylene terephthalate, polysulfone, polyether ether sulfone, polyether imide, modified polyphenylene ether, polyphenylene sulfide, polyphenylene oxide, polyimide, modified polyimide, an epoxy resin, a cycloolefin polymer, polynorbornene, a perfluoroalkoxy fluorine polymer, polytetrafluoroethylene, vinylidene fluoride, a vinyl resin, a phenol resin, polyacetal, nylon, a liquid crystal polymer, and copolymers of the polymers.

In a case where the surface of the resin substrate is roughened using a chemical agent as in Patent Documents 1 to 4, the kind of the resin material that can be roughened is limited according to the chemical agent. Meanwhile, the method for manufacturing the laminated structure 10 of the present invention is highly versatile because the resin substrate 20 including any resin material can be used as long as the metal layer 40 can enter the resin substrate 20.

Next, as shown in FIG. 3B, when the precursor laminate 60 obtained by forming the metal precursor 62 having a two-layer structure on the resin substrate 20 is heated, a part of the metal layer 40 penetrates the barrier film 30, which is a continuous film, and further enters into the inside of the resin substrate 20. When heating is continued, a part of the metal layer 40 further enters into the inside of the resin substrate 20, and the extending portion 44 as shown in FIG. 2 can be formed.

The mechanism in which the part 41 of the metal layer 40 penetrates the barrier film 30 and enters into the inside of the resin substrate 20 is not clear, but is presumed as follows.

In the step of heating, the first metal element contained in the barrier film 30 and the second metal element contained in the metal layer 40 are thermally diffused with each other, and the through hole 32 is formed in the barrier film 30. It is presumed that the formation of the through hole 32 is affected by a structural defect of the barrier film 30, variation in the size of crystal grains forming the barrier film 30, eutectoid of contamination in the barrier film 30, and the like (referred to as “structure defects of the barrier film 30”). It is expected that when a part with a structure defect and a part without a structure defect are compared in the barrier film 30, the diffusion speed of metal elements between the first metal element and the second metal element is different (the diffusion speed is faster in the part with a structure defect). The barrier film 30 is locally thinned, and the through hole 32 is finally formed. A structure defect of the barrier film 30 randomly occurs in the barrier film 30, and therefore the through hole 32 is also randomly formed at a position corresponding to the position of the structure defect.

When the through hole 32 is formed in the barrier film 30, the part 41 of the metal layer 40 is brought into contact with the resin substrate 20 through the through hole 32. The part 41 of the metal layer 40 starts to enter into the inside of the resin substrate 20 softened by heating (FIG. 3B), and further enters into the inside of the resin substrate 20 while extruding the resin material constituting the resin substrate 20, and thus the extending portion 44 is formed (FIG. 2).

It is presumed that the laminated structure 10 as shown in FIG. 2 is obtained by such a mechanism.

The heating conditions in the step of heating the precursor laminate 60 are, for example, a heating temperature of higher than (Tm−30)° C. and lower than Tm° C., and a heating time of 1 minute to 120 minutes. Tm (° C.) represents the melting point of the resin material used in the resin substrate 20. In a case where the resin substrate 20 is formed of a mixed material of a plurality of resin materials, the melting point of the mixed material is measured or calculated and used as Tm. In a case where the resin substrate 20 is formed by layering a plurality of resin sheets including different resin materials, the melting point of the resin material of the resin sheet in contact with the metal precursor 62 is used as Tm.

The heating conditions (the heating temperature and the heating time) in the step of heating can affect the dimension of the through hole 32 of the barrier film 30 and the dimension and the shape of the cavity 24 of the resin substrate 20 (that is, the dimension and the shape of the extending portion 44 included in the part 41 of the metal layer 40). By setting the heating conditions within the above-described ranges, the extending portion 44 can be formed that has a dimension and a shape such that the extending portion 44 functions as an anchor capable of fixing the metal layer 40 to the resin substrate 20.

It has been confirmed that the laminated structure 10 according to the first embodiment can be manufactured by setting the heating conditions within the above-described ranges, and in a case where the heating conditions are out of the ranges, there is a possibility that the laminated structure 10 having a similar internal structure can be manufactured. For example, it is presumed that in a case where the heating temperature is somewhat lower than the above-described temperature range, the laminated structure 10 can be manufactured by lengthening the heating time.

However, if the heating temperature is excessively higher than the above-described temperature range, or if the heating time is excessively longer than the above-described time range when the heating temperature is within the above-described temperature range, all of the barrier film 30 may disappear. If the barrier film 30 is absent, the entire metal layer 40 enters the resin substrate 20, so that a structure having an anchor function (the part 41 of the metal layer 40 in FIG. 2) is not formed, and an effect of improving adhesion between the resin substrate 20 and the metal layer 40 may be not obtained. When changed, the heating temperature and the heating time need to be carefully selected.

In this way, the laminated structure 10 shown in FIG. 2 is obtained by the first method for manufacturing.

### Second Embodiment-2: Second Method for Manufacturing Laminated Structure 10

The second method for manufacturing the laminated structure 10 is different from the first method for manufacturing in the structure and the forming method of the metal precursor contained in the precursor laminate. The second method for manufacturing is similar to the first method for manufacturing except for the above-described structure and forming method. Regarding the second method for manufacturing described in the second embodiment-2, differences from the first method for manufacturing will be mainly described, and description of matters similar to those in the first method for manufacturing may be omitted.

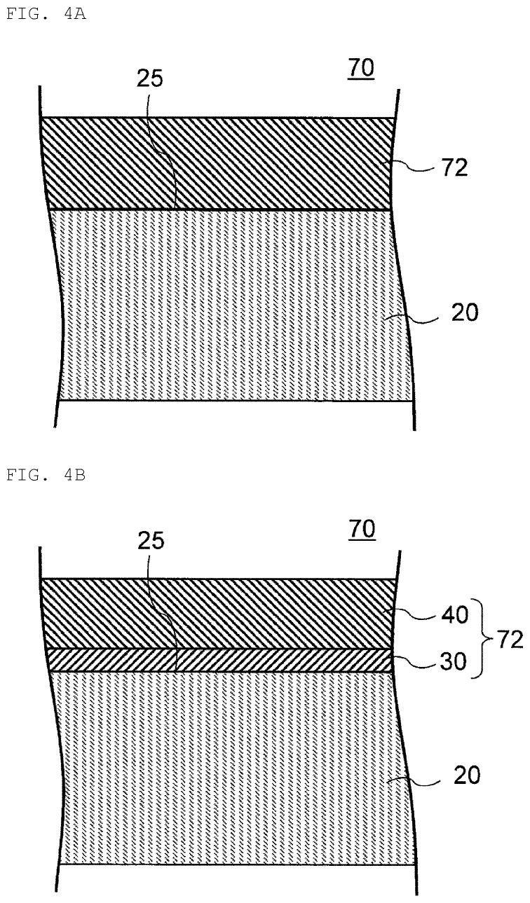

FIGS. 4A and 4B are schematic enlarged sectional views for explaining the second method for manufacturing the laminated structure 10.

The second method for manufacturing the laminated structure 10 includes a step of heating a precursor laminate 70 containing the resin substrate 20 and a metal precursor 72 positioned on the resin substrate 20 and containing the first metal element and the second metal element. As shown in FIG. 4A, in the second method for manufacturing according to the second embodiment-2, the metal precursor 72 is a single plating layer disposed on the resin substrate 20. This plating layer contains the first metal element and the second metal element.

The ratio of the content of the first metal element to the content of the second metal element in the metal precursor 72 can be, for example, first metal element content (mass %):second metal element content (mass %)=0.1:99.9 to 40:60.

The metal precursor 72 formed of a single plating layer can be formed by electroless plating. the plating solution, the plating conditions, and the like used for the electroless plating can be known ones. Before the electroless plating, the front surface 25 of the resin substrate 20 is preferably pretreated with a known pretreatment method such as catalyst application.

When the precursor laminate 70 obtained by forming the metal precursor 72 formed of a single plating layer on the resin substrate 20 is heated, the metal precursor 72 is formed into a two-layer structure including the barrier film 30 positioned on the resin substrate 20 and containing the first metal element and the metal layer 40 positioned on the barrier film 30 and containing the second metal element (see FIG. 4B).

The two-layer structure including the barrier film 30 and the metal layer 40 can be achieved by a phenomenon in which the first metal element in the metal precursor 72 segregates on the front surface 25 of the resin substrate 20. The mechanism of this segregation is not clear, but it is presumed that the first metal element in the metal precursor 72 diffuses in all directions by heating and at the time of reaching the front surface 25 of the resin substrate 20, the first metal element is immobilized on the surface 25. Thus, the first metal element segregates on the front surface 25 of the resin substrate 20 and becomes the barrier film 30.

The metal precursor 72 having a two-layer structure including the barrier film 30 and the metal layer 40 is further heated, and thus, similarly to the first method for manufacturing according to the second embodiment-1, the through hole 32 is formed in the barrier film 30 as a continuous film, and the part 41 of the metal layer 40 enters into the inside of the resin substrate 20 through the through hole 32 (FIG. 3B). When heating is continued, the part 41 of the metal layer 40 further enters into the inside of the resin substrate 20, and the extending portion 44 as shown in FIG. 2 can be formed.

The second method for manufacturing may further include a preheating step of heating the metal precursor 72 at 190° C. to 210° C. before the step of heating in order to form the metal precursor 72 formed of a single plating layer into a two-layer structure including the barrier film 30 and the metal layer 40.

The preheating time can be freely set, and may be, for example, 30 minutes to 90 minutes.

Preferable heating conditions (heating temperature and heating time) in the step of heating, a preferable relation between the diffusion coefficients of the first metal element and the second metal element, kinds of metal elements suitable for the first metal element and the second metal element, kinds of resin materials suitable for the resin substrate 20, and the like are similar to those in the first method for manufacturing described in the second embodiment-1.

In this way, the laminated structure 10 shown in FIG. 2 is obtained by the second method for manufacturing.

In the first and second methods for manufacturing described in the second embodiment-1 and the second embodiment-2, the laminated structure 10 with improved adhesion between the resin substrate 20 and the metal layer 40 can be manufactured without using a chemical liquid as those described in Patent Documents 1 to 4.

### Third Embodiment

In the third embodiment, modifications (first to third modifications) of the laminated structure will be described. These modifications can also be included in the scope of the present invention.

### (i) First Modification

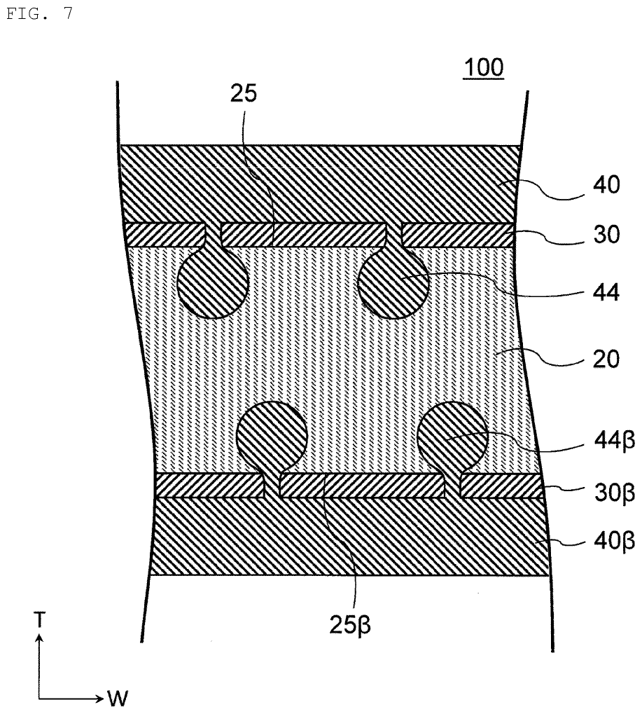

FIG. 7 shows a laminated structure 100 according to the first modification, and the laminated structure 100 is different from the laminated structure 10 of the first embodiment in that a barrier film and a metal layer are provided on both surfaces of a resin substrate 20. The laminated structure 100 is similar to the laminated structure 10 of the first embodiment except for the above-described configuration.

The laminated structure 100 includes barrier films 30 and 30β and metal layers 40 and 40β on both surfaces (a front surface 25 and a back surface 25B) of the resin substrate 20, and a part of the metal layer 40 and a part of the metal layer 40β penetrate the barrier films 30 and 30β and extend into the inside of the resin substrate 20 to form extending portions 44 and 44β. Such a laminated structure 100 is suitable for, for example, a printed board having metal wirings on both surfaces.

The method for manufacturing the laminated structure 100 is basically similar to the method for manufacturing the laminated structure 10 described in the second embodiment. However, formation of a metal precursor on the resin substrate 20 is changed so that metal precursors are formed on both surfaces of the resin substrate 20.

### (ii) Second Modification

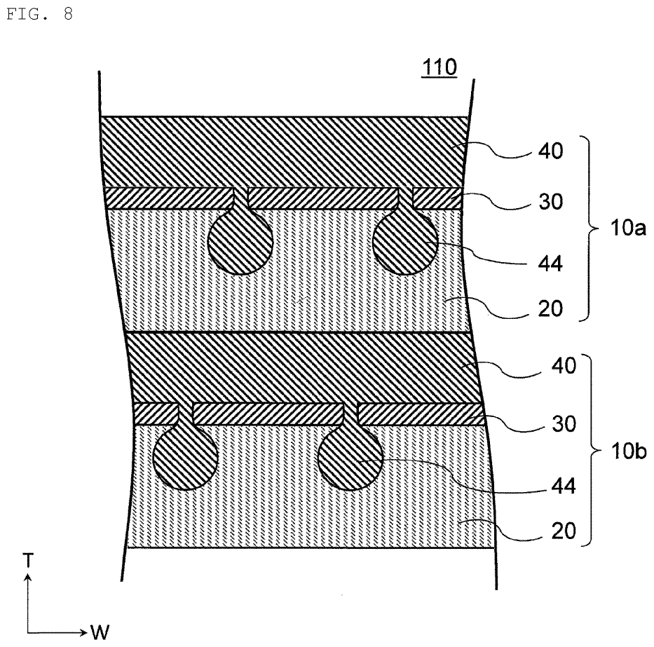

FIG. 8 shows a laminated structure 110 according to the second modification, and the laminated structure 110 has a structure in which two laminated structures 10 according to the first embodiment are overlapped and integrated.

The laminated structure 10 according to the first embodiment (including the resin substrate 20, the barrier film 30, the metal layer 40, and the extending portion 44) is regarded as one laminated structure unit (simply referred to as “unit”) 10a or 10b, and the two units are overlapped so that the metal layer 40 of the first unit 10a and the resin substrate 20 of the second unit 10b are in contact with each other, and these units are joined.

The method for manufacturing the laminated structure 110 further includes, in addition to the method for manufacturing the laminated structure 10 described in the second embodiment, a step of joining the two laminated structures 10 (two units 10a and 10b) obtained by this method. In the step of joining the two units 10a and 10b, a known joining method such as adhesion using an adhesive agent can be used.

### (iii) Third Modification

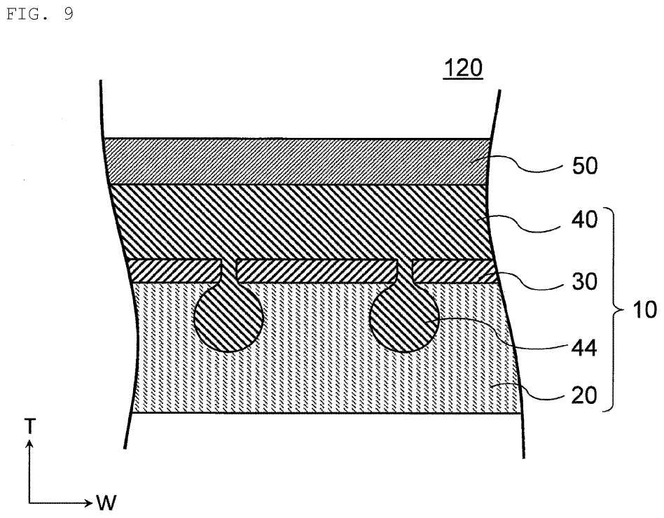

FIG. 9 shows a laminated structure 120 according to the third modification, and the laminated structure 120 is different from the laminated structure 10 of the first embodiment in that a second metal layer 50 is further provided on the metal layer 40. The laminated structure 120 is similar to the laminated structure 10 of the first embodiment except for the above-described configuration.

The second metal layer 50 can have a function as a protective layer capable of protecting the metal layer 40 or as a surface treatment for mounting. The second metal layer 50 preferably contains, for example, one or more metal elements of Au, Pd, Sn, and Ni. In a case where the second metal layer 50 is provided as a surface treatment for mounting, a two-layer structure such as Ni/Au and a three-layer structure such as Ni/Pd/Au are particularly preferable.

The method for manufacturing the laminated structure 120 further includes, in addition to the method for manufacturing the laminated structure 10 described in the second embodiment, a step of forming the second metal layer 50 on the metal layer 40 of the laminated structure 10 obtained by this method. The laminated structure 120 can also be formed, after forming the metal precursor, by performing the step of forming the second metal layer 50 on the metal precursor and then heating the metal precursor (and the second metal layer 50).

In the step of forming the second metal layer 50, the second metal layer 50 is formed on a surface of the metal layer 40 by, for example, electrolytic plating, electroless plating, a sputtering method, or the like.

### Fourth Embodiment

In the fourth embodiment, modifications (first to third modifications) of the resin substrate used in the laminated structure will be described. These modifications can also be included in the scope of the present invention.

### (i) First Modification

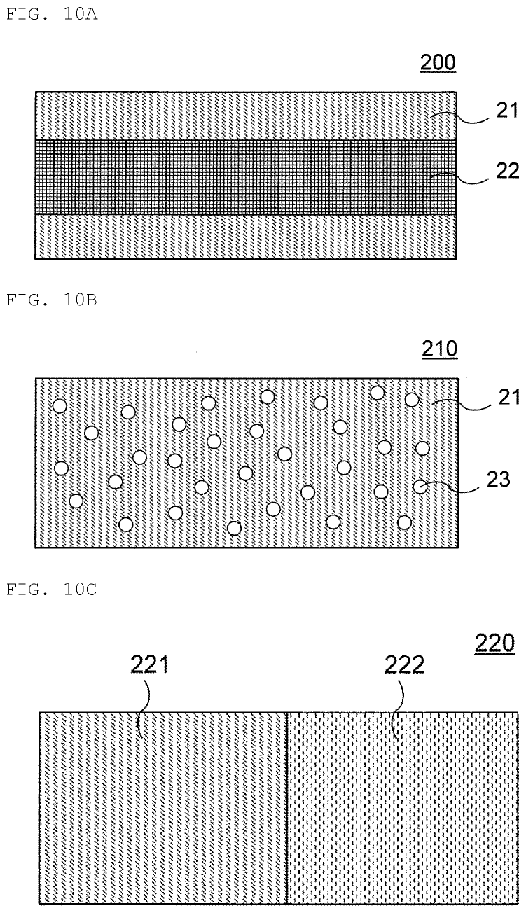

FIG. 10A shows a resin substrate 200 according to the first modification, and the resin substrate 200 includes a resin layer 21 and a reinforcing material 22 embedded in the resin layer 21. If the reinforcing material 22 is included, the strength of the resin substrate 200 can be improved. The reinforcing material 22 can be embedded in a range excluding the surface of the resin substrate 200 so as not to inhibit formation of the extending portion 44.

The resin layer 21 can be formed of a resin material that can be used in the resin substrate 20 described in the first embodiment.

As the reinforcing material 22, for example, glass cloth or the like is suitable.

The resin substrate 200 including the reinforcing material 22 can be manufactured with a known method such as a method in which a reinforcing material is immersed in a resin material before curing and then the resin is cured, or a method in which a reinforcing material impregnated with a resin (prepreg) is cured. Alternatively, a commercially available resin substrate 200 may be used.

### (ii) Second Modification

FIG. 10B shows a resin substrate 210 according to the second modification, and the resin substrate 210 includes a resin layer 21 and a filler 23 dispersed in the resin layer 21. As the filler 23, for example, particles of a metal oxide such as silica, alumina, or talc are suitable.

The resin layer 21 can be formed of a resin material that can be used in the resin substrate 20 described in the first embodiment.

The resin substrate 210 including the filler 23 can be manufactured with a known method such as a method in which the filler 23 is added to and mixed with the resin material before curing, and then the mixture is cured. Alternatively, a commercially available resin substrate 210 may be used.

### (iii) Third Modification

FIG. 10C shows a resin substrate 220 according to the third modification, and the resin substrate 220 includes a resin portion 221 and a ceramic portion 222.

The resin portion 221 can be formed of a resin material that can be used in the resin substrate 20 described in the first embodiment.

The ceramic portion 222 can be formed of, for example, a ceramic material such as alumina or aluminum nitride. The extending portion 44 is formed in the resin portion 221, but is not formed in the ceramic portion 222.

### Examples

Various tests were performed using samples produced under the following conditions. The samples were produced with the second method for manufacturing (the second embodiment-2).

(Production of samples)

A liquid crystal polymer (LCP) sheet (melting point Tm (catalog value)=310° C.) of 50 mm length×50 mm width×0.1 mm thickness was used as a resin substrate 20, and a metal precursor 72 formed of a single plating layer as shown in FIG. 4A was produced on a front surface 25 of the resin substrate 20. Ni was used as a first metal element, and Cu was used as a second metal element.

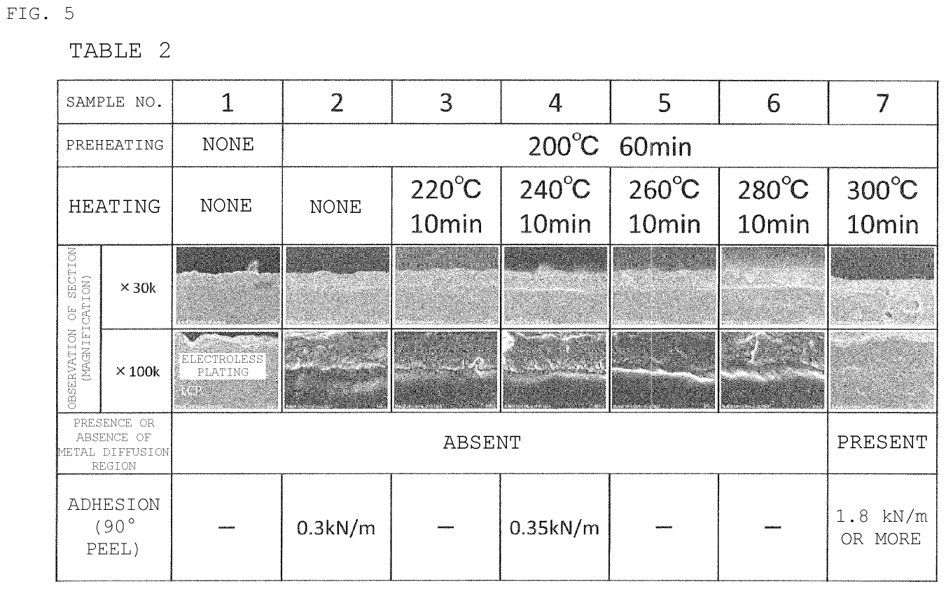

Pretreatments of the resin substrate 20 before producing the metal precursor 72 (Treatments No. 1 to 4) and electroless plating for production of the metal precursor 72 (Treatment No. 5) were performed in accordance with the conditions in Table 1, and thus 10 samples of a precursor laminate 70 were produced. Each obtained sample of the precursor laminate 70 was subjected to preheating (Treatment No. 6) and heating (Treatment No. 7). The detailed conditions of the preheating and the heating are shown in Table 2 (FIG. 5).

A heating treatment was performed under the preheating conditions and the heating conditions shown in Table 2 (see FIG. 5), and thus measurement samples (samples No. 1 to 7) were obtained. Each measurement sample was subjected to various measurement.

TABLE 1

| | | Composition and | | | | | |
|---|---|---|---|---|---|---|---|
| Treatment | | concentration of used | | | Bath | Treatment | |
| No. | Treatment | chemical agent | | | temperature | time | Note |
| 1 | Conditioner | TOP LECS | 80 | ml/L | 50° C. | 5 min | — |
| | | CONDITIONER | | | | | |
| 2 | Predip | TOP LECS | 50 | ml/L | 25° C. | 1 min | — |
| | | PREDIP M | | | | | |
| 3 | Catalyst | TOP LECS | 50 | ml/L | 40° C. | 5 min | Alkali |
| | application | CATALYST A | | | | | catalyst |
| | | TOP LECS | 50 | ml/L | | | |
| | | CATALYST B | | | | | |
| 4 | Activation | TOP LECS | 8 | ml/L | 25° C. | 5 min | — |
| | | ACCELERATOR | | | | | |
| | | Boric acid | 6 | g/L | | | |
| 5 | Electroless | TOP LECS | 50 | ml/L | 32° C. | 10 min | Rochelle |
| | Cu plating | COPPER A | | | | | salt-based |
| | (containing | TOP LECS | 80 | ml/L | | | Cu plating |
| | Ni) | COPPER M | | | | | |
| | | TOP LECS | 15 | ml/L | | | |
| | | COPPER C | | | | | |
| | | Electroless | 3 | ml/L | | | |
| | | copper R-N | | | | | |
| 6 | Preheating | — | — | | 200° C. | 60 min | SPHH-102 |
| | step | | | | | | manufactured |
| 7 | Heating step | — | — | | 220 to | 10 min | by ESPEC |
| | | | | | 300° C. | | CORP. in air |

### Sectional SEM)

The measurement sample was cut in the thickness direction, and the section was observed with a scanning electron microscope (SEM). The measurement surface was coated with Pt using a field emission scanning electron microscope SU8230 manufactured by Hitachi High-Tech Corporation, and SEM images were acquired at a magnification of 30000 times (×30 k) and 100000 times (×100 k) under the condition of an acceleration voltage of 3.0 kV.

Table 2 (see FIG. 5) shows the SEM images of the measurement samples.

A part 41 of a metal layer 40 (an extending portion 44) was not formed in the resin substrate 20, among these SEM images, in the sample No. 1 not subjected to preheating and heating, the sample No. 2 not subjected to heating, and the samples No. 3 to 6 subjected to heating at a temperature of 280° C. (corresponding to the melting point (Tm) of the resin substrate 20-30° C.) or lower.

In the sample No. 7 subjected to heating at a temperature in a range of higher than 280° C. (corresponding to Tm−30° C.) and lower than 310° C. (corresponding to Tm), the extending portion 44 was formed inside the resin substrate 20.

### Sectional STEM-EDX)

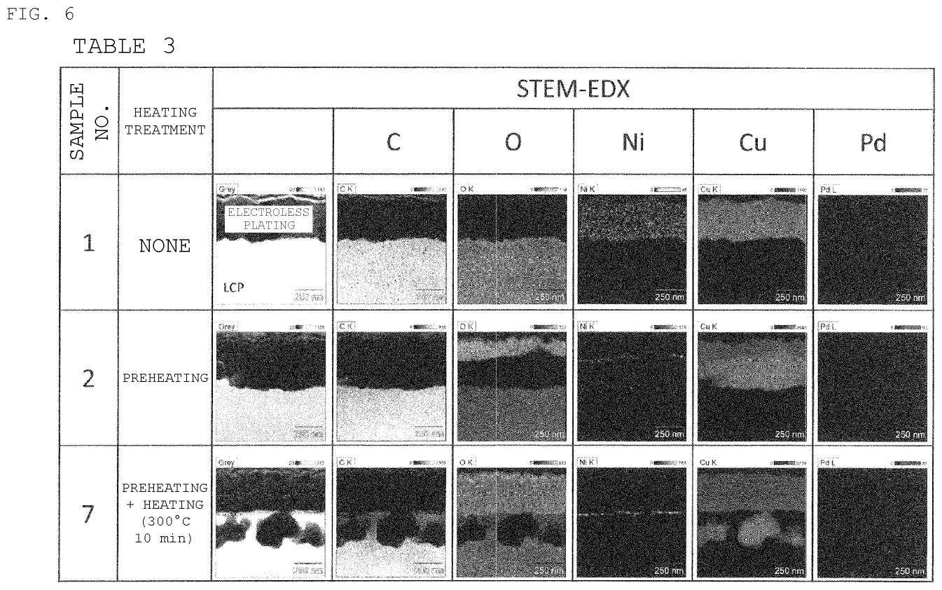

The measurement sample was cut in the thickness direction, and the section was analyzed with a STEM-EDX. A target site (arbitrary position) was sampled using JEM-F200/Noran system 7 manufactured by JEOL Ltd. with a focused ion beam (FIB) to obtain a TEM observation sample (FIB lift-out method). Table 3 (see FIG. 6) shows the element mapping of each element obtained by STEM-EDX analysis of the samples No. 1, 2, and 7.

From the result of element mapping of Ni, the following has been found.

In the sample No. 1 not subjected to preheating and heating, Ni was distributed over the entire of the electroless plating layer (metal precursor 72).

In the sample No. 2 subjected to preheating but not subjected to heating and the sample No. 7 subjected to preheating and heating at 300° C., Ni was unevenly distributed at the interface between the electroless plating layer (metal precursor 72) and the LCP sheet (resin substrate 20), and a barrier film 30 containing Ni was formed. In each of the samples No. 2 and 7, the thickness of the barrier film 30 was measured at arbitrary 5 locations, and the average of the thicknesses was determined to find that the average was about 30 nm in both of the samples.

From the result of element mapping of Cu, the following has been found.

In the sample No. 1 not subjected to preheating and heating and the sample No. 2 subjected to preheating but not subjected to heating, a part 41 of the metal layer 40 (extending portion 44) was not formed inside the LCP sheet (resin substrate 20).

In the sample No. 7 subjected to preheating and heating at 300° C., Cu contained in the metal layer 40 was confirmed inside the LCP sheet (resin substrate 20). As a result, it has been found that the part 41 of the metal layer 40 extends to the inside of the resin substrate 20 to form the extending portion 44.

As a result of confirming the result of element mapping of C together with the result of element mapping of Cu, C was not confirmed in the part where the extending portion 44 was formed, and thus it has been confirmed that the resin material of the resin substrate 20 is extruded (that is, the resin substrate 20 has a cavity 24, and the cavity 24 is filled with the part 41 of the metal layer 40). Peel strength: 90° peel evaluation)

In order to measure the adhesion between the resin substrate 20 and the metal layer 40, the peel strength of the metal layer 40 was measured for the measurement samples No. 2, 4, and 7. The measurement was performed in accordance with JIS C 6471: 1995 and JIS C 6481: 1996.

The measurement conditions and the measurement procedure were as follows.
Measuring apparatus: RTF-1210 manufactured by A & D Company, Limited
Measurement method: width of peeling copper foil: 10 mm, peeling in 90° direction, peel rate: 50 mm/min

### Measurement Procedure

(1) In accordance with the conditions in Table 4, the measurement sample was washed with an acid, and then subjected to thick electrolytic copper plating. The target film thickness of the electrolytic copper plating was 30 μm.
(2) A cut with a width of 10 mm was made in the electrolytic copper plating film with a cutter, one end was pinched with a jig, and a peel test was performed in the 90° direction. Table 2 (see FIG. 5) shows the measurement results.

TABLE 4

| | | Composition and | | | | | |
|---|---|---|---|---|---|---|---|
| Treatment | | concentration of used | | | Bath | Current | |
| No. | Step | chemical agent | | | temperature | density | Time |
| 1 | Acid washing | 98% Sulfuric acid | 50 | ml/L | 25° C. | — | 5 min |
| 2 | Electrolytic | Copper sulfate | 150 | g/L | 35° C. | 5ASD | 32 min |
| | copper | pentahydrate | | | | | |
| | plating | 98% Sulfuric acid | 200 | g/L | | | |
| | | Chloride ion | 100 | mg/L | | | |
| | | Leveler | 12 | ml/L | | | |
| | | Brightener | 8 | ml/L | | | |

It has been found that in the samples No. 1 and 2 in which a part 41 of the metal layer 40 (extending portion 44) was not formed inside the resin substrate 20, the peel strength of the metal layer 40 is low and the adhesion between the resin substrate 20 and the metal layer 40 is low.

It has been found that in the sample No. 7 in which the part 41 of the metal layer 40 (extending portion 44) was formed inside the resin substrate 20, the peel strength of the metal layer 40 is high and the adhesion between the resin substrate 20 and the metal layer 40 is high.

The disclosure herein may include the following aspects.

<1> A laminated structure including: a resin substrate; a barrier film positioned on the resin substrate, the barrier film containing a first metal element; and a metal layer positioned on the barrier film, the metal layer containing a second metal element, wherein a part of the metal layer penetrates the barrier film and extends to an inside of the resin substrate.

<2> The laminated structure according to <1>, wherein in a sectional view in a thickness direction of the resin substrate, a width of the part of the metal layer at a position of an interface between the resin substrate and the barrier film is smaller than a maximum width of the part of the metal layer at the inside of the resin substrate.

<3> The laminated structure according to <1> or <2>, wherein the first metal element has a smaller diffusion coefficient into the resin substrate than the second metal element.

<4> The laminated structure according to any one of <1> to <3>, wherein the first metal element comprises one or more of Fe, V, Ni, Ti, Ca, Ag, Zn, Al, Mg, Rh, Pt, Au, and Pd, and the second metal element comprises one or more of Co, Mn, and Cu.

<5> The laminated structure according to any one of <1> to <4>, wherein the barrier film has a thickness of 10 nm to 100 nm.

<6> The laminated structure according to any one of <1> to <5>, wherein the resin substrate contains one or more of polymers of acrylonitrile-butadiene-styrene (ABS), polycarbonate/acrylonitrile-butadiene-styrene (PC/ABS), acrylonitrile-styrene-acrylate (ASA), silicon-based composite rubber-acrylonitrile-styrene (SAS), noryl, polypropylene, polycarbonate (PC), a polycarbonate-based alloy, acrylonitrile-styrene, polyacetate, polylactic acid, polystyrene, polyamide, aromatic polyamide, polyethylene, polyether ketone, polyethylene terephthalate, polybutylene terephthalate, polysulfone, polyether ether sulfone, polyether imide, modified polyphenylene ether, polyphenylene sulfide, polyphenylene oxide, polyimide, modified polyimide, an epoxy resin, a cycloolefin polymer, polynorbornene, a perfluoroalkoxy fluorine polymer, polytetrafluoroethylene, vinylidene fluoride, a vinyl resin, a phenol resin, polyacetal, nylon, a liquid crystal polymer, and copolymers of the polymers.

<7> A method for manufacturing a laminated structure, the laminated structure including a resin substrate, a barrier film positioned on the resin substrate and containing a first metal element, and a metal layer positioned on the barrier film and containing a second metal element, the metal layer having a part in contact with the resin substrate through the barrier film, the resin substrate having a metal diffusion region extending inward from a contact portion in contact with the metal layer, the metal diffusion region in which metal elements of a kind identical with a kind of the second metal element are diffused, the method including a step of heating a precursor laminate containing the resin substrate and a metal precursor positioned on the resin substrate, the metal precursor containing the first metal element and the second metal element.

<8> The method for manufacturing a laminated structure according to <7>, wherein the metal precursor has a two-layer structure including the barrier film disposed on the resin substrate and containing the first metal element and the metal layer disposed on the barrier film and containing the second metal element, and the step of heating the precursor laminate makes the part of the metal layer penetrate the barrier film and extend to an inside of the resin substrate.

<9> The method for manufacturing a laminated structure according to <7> or <8>, wherein the metal precursor is a single plating layer containing the first metal element and the second metal element, and the step of heating the precursor laminate makes the metal precursor have a two-layer structure including the barrier film positioned on the resin substrate and containing the first metal element and the metal layer positioned on the barrier film and containing the second metal element, and makes the part of the metal layer penetrate the barrier film and extend to the inside of the resin substrate.

<10> The method for manufacturing a laminated structure according to any one of <7> to <9>, further including a step of preheating the precursor laminate at 190° C. to 210° C. before the step of heating.

<11> The method for manufacturing a laminated structure according to any one of <7> to <10>, wherein the first metal element has a smaller diffusion coefficient into the resin substrate than the second metal element.

<12> The method for manufacturing a laminated structure according to any one of <7> to <11>, wherein the step of heating the precursor laminate includes heating at a temperature higher than (Tm−30) ° C. and lower than Tm° C. for 1 minute to 120 minutes, Tm° C. representing a melting point of a resin material used in the resin substrate.

The laminated structure according to the present invention can be used as, for example, a copper-clad laminate used in a printed board or the like.

### DESCRIPTION OF REFERENCE SYMBOLS

10, 110, 120: Laminated structure
20, 200, 210, 220: Resin substrate
21: Resin layer
221: Resin portion
222: Ceramic portion
22: Reinforcing material
23: Filler
24: Cavity
24w: Maximum width of cavity
25: Front surface
26: Cavity opening
26w: Opening width
30: Barrier film
32: Through hole
40: Metal layer
41: Part of metal layer
42: Penetrating portion
44: Extending portion
50: Second metal layer
60, 70: Precursor laminate
62, 72: Metal precursor
W1: Width of part of metal layer at position of interface
W2: Maximum width of part of metal layer inside resin substrate

1. A laminated structure comprising:
a resin substrate;
a barrier film on the resin substrate, the barrier film containing a first metal element; and
a metal layer on the barrier film, the metal layer containing a second metal element,
wherein a part of the metal layer penetrates the barrier film and extends to an inside of the resin substrate.

2. The laminated structure according to claim 1, wherein in a sectional view in a thickness direction of the resin substrate, a width of the part of the metal layer at a position of an interface between the resin substrate and the barrier film is smaller than a maximum width of the part of the metal layer at the inside of the resin substrate.

3. The laminated structure according to claim 2, wherein the first metal element has a smaller diffusion coefficient into the resin substrate than the second metal element.

4. The laminated structure according to claim 1, wherein the first metal element has a smaller diffusion coefficient into the resin substrate than the second metal element.

5. The laminated structure according to claim 1, wherein
the first metal element comprises one or more of Fe, V, Ni, Ti, Ca, Ag, Zn, Al, Mg, Rh, Pt, Au, and Pd, and
the second metal element is one or more selected from Co, Mn, and Cu.

6. The laminated structure according to claim 1, wherein the barrier film has a thickness of 10 nm to 100 nm.

7. The laminated structure according to claim 1, wherein the resin substrate contains one or more of polymers of acrylonitrile-butadiene-styrene (ABS), polycarbonate/acrylonitrile-butadiene-styrene (PC/ABS), acrylonitrile-styrene-acrylate (ASA), silicon-based composite rubber-acrylonitrile-styrene (SAS), noryl, polypropylene, polycarbonate (PC), a polycarbonate-based alloy, acrylonitrile-styrene, polyacetate, polylactic acid, polystyrene, polyamide, aromatic polyamide, polyethylene, polyether ketone, polyethylene terephthalate, polybutylene terephthalate, polysulfone, polyether ether sulfone, polyether imide, modified polyphenylene ether, polyphenylene sulfide, polyphenylene oxide, polyimide, modified polyimide, an epoxy resin, a cycloolefin polymer, polynorbornene, a perfluoroalkoxy fluorine polymer, polytetrafluoroethylene, vinylidene fluoride, a vinyl resin, a phenol resin, polyacetal, nylon, a liquid crystal polymer, and copolymers of the polymers.

8. A method for manufacturing a laminated structure, the method comprising:
heating a precursor laminate containing a resin substrate and a metal precursor on the resin substrate, the metal precursor containing a first metal element and a second metal element to form the laminated structure including:
the resin substrate;
a barrier film on the resin substrate and containing the first metal element; and
a metal layer on the barrier film and containing the second metal element,
the metal layer having a part in contact with the resin substrate through the barrier film, and
the resin substrate having a metal diffusion region extending inward from a contact portion in contact with the metal layer, the metal diffusion region in which metal elements of a kind identical with a kind of the second metal element are diffused during the heating.

9. The method for manufacturing a laminated structure according to claim 8, wherein
the metal precursor has a two-layer structure including the barrier film on the resin substrate and containing the first metal element and the metal layer on the barrier film and containing the second metal element, and
the heating of the precursor laminate makes the part of the metal layer penetrate the barrier film and extend to an inside of the resin substrate.

10. The method for manufacturing a laminated structure according to claim 9, wherein in a sectional view in a thickness direction of the resin substrate, a width of the part of the metal layer at a position of an interface between the resin substrate and the barrier film is smaller than a maximum width of the part of the metal layer at the inside of the resin substrate.

11. The method for manufacturing a laminated structure according to claim 8, wherein
the metal precursor is a single plating layer containing the first metal element and the second metal element, and
the heating of the precursor laminate:
makes the metal precursor have a two-layer structure including the barrier film on the resin substrate and containing the first metal element and the metal layer on the barrier film and containing the second metal element, and
makes the part of the metal layer penetrate the barrier film and extend to the inside of the resin substrate.

12. The method for manufacturing a laminated structure according to claim 11, wherein in a sectional view in a thickness direction of the resin substrate, a width of the part of the metal layer at a position of an interface between the resin substrate and the barrier film is smaller than a maximum width of the part of the metal layer at the inside of the resin substrate.

13. The method for manufacturing a laminated structure according to claim 11, wherein a ratio of a content of the first metal element to a content of the second metal element in the metal precursor is 0.1:99.9 to 40:60.

14. The method for manufacturing a laminated structure according to claim 8, further comprising preheating the precursor laminate at 190° C. to 210° C. before the heating.

15. The method for manufacturing a laminated structure according to claim 8, wherein the first metal element has a smaller diffusion coefficient into the resin substrate than the second metal element.

16. The method for manufacturing a laminated structure according to claim 8, wherein
the heating of the precursor laminate is conducted at a temperature higher than (Tm−30)° C. and lower than Tm° C. for 1 minute to 120 minutes, and
Tm° C. represents a melting point of a resin material of the resin substrate.

17. The method for manufacturing a laminated structure according to claim 8, wherein a ratio of a content of the first metal element to a content of the second metal element in the metal precursor is 0.1:99.9 to 40:60.

18. The method for manufacturing a laminated structure according to claim 8, wherein
the first metal element comprises one or more of Fe, V, Ni, Ti, Ca, Ag, Zn, Al, Mg, Rh, Pt, Au, and Pd, and
the second metal element is one or more selected from Co, Mn, and Cu.

19. The method for manufacturing a laminated structure according to claim 8, wherein the resin substrate contains one or more of polymers of acrylonitrile-butadiene-styrene (ABS), polycarbonate/acrylonitrile-butadiene-styrene (PC/ABS), acrylonitrile-styrene-acrylate (ASA), silicon-based composite rubber-acrylonitrile-styrene (SAS), noryl, polypropylene, polycarbonate (PC), a polycarbonate-based alloy, acrylonitrile-styrene, polyacetate, polylactic acid, polystyrene, polyamide, aromatic polyamide, polyethylene, polyether ketone, polyethylene terephthalate, polybutylene terephthalate, polysulfone, polyether ether sulfone, polyether imide, modified polyphenylene ether, polyphenylene sulfide, polyphenylene oxide, polyamide, polyimide, modified polyimide, an epoxy resin, a cycloolefin polymer, polynorbornene, a perfluoroalkoxy fluorine polymer, polytetrafluoroethylene, vinylidene fluoride, a vinyl resin, a phenol resin, polyacetal, nylon, a liquid crystal polymer, and copolymers of the polymers.
